(19) United States
(12) Patent Application Publication
(10) Pub. No.: US 2020/0118376 A1
(43) Pub. Date: Apr. 16, 2020

(54) SERVER-RECOMMENDED DIGITAL TICKET CHECKING MECHANISMS

(71) Applicant: Beijing Pony Media Culture Development Co., Ltd., Beijing (CN)

(72) Inventors: Jie CAO, Hangzhou (CN); Yuhui FENG, Hangzhou (CN); Wei MENG, Hangzhou (CN); Xinwei LI, Hangzhou (CN); Shuai HE, Hangzhou (CN); Chongyuan TANG, Hangzhou (CN)

(21) Appl. No.: 16/471,759

(22) PCT Filed: Dec. 14, 2017
(86) PCT No.: PCT/CN2017/116096

§ 371 Date: Jun. 20, 2019

(30) Foreign Application Priority Data
Dec. 21, 2016 (CN) 201611186728.3

(51) Int. Cl. G07C 9/28; G07C 9/29; G07B 11/00; G07D 7/202; G06K 17/00

(52) U.S. Cl. CPC G07C 9/28; G07C 9/29; G06K 17/0029; G07D 7/202; G07B 11/00

(57) ABSTRACT

The disclosure provides a method, system, and apparatus for ticket checking based on a server-recommended ticket checking scheme. The method includes: receiving a ticket checking scheme recommendation request; responding to the ticket checking scheme recommendation request, retrieving a ticket checking scheme that is matched based on eligible data included in the ticket checking scheme recommendation request; matching the data included in the ticket checking scheme recommendation request with the ticket checking scheme; and setting and storing at least one form of password data for ticket checking in the ticket checking scheme after data matching. The disclosed embodiments reasonably recommend a ticket checking mode on the basis of existing venue characteristics, while ensuring the security of ticket checking. Ticket checking efficiency is thereby improved, and staff and equipment input and ticket checking costs are thereby reduced.

### CROSS-REFERENCE TO RELATED APPLICATIONS

This application is a national stage entry of Int'l Appl. No. PCT/CN2017/116096, filed Dec. 14, 2017 and entitled “METHOD, SYSTEM AND DEVICE FOR CHECKING TICKET BASED ON TICKET CHECK SOLUTION RECOMMENDED BY SERVER” which claims the benefit of priority of Chinese Application No. 201611186728.3, titled “METHOD, SYSTEM AND DEVICE FOR CHECKING TICKET BASED ON TICKET CHECK SOLUTION RECOMMENDED BY SERVER,” filed on Dec. 21, 2016, both of which are hereby incorporated by reference in their entirety.

### BACKGROUND

### Technical Field

The disclosed embodiments relate to the technical field of ticket checking, and in particular, to methods, systems, and apparatuses for ticket checking via a server-recommended ticket checking scheme.

### Description of the Related Art

In existing ticket checking processes, the following techniques of verifying tickets to ensure the uniqueness of checked tickets are employed. In a first technique, customers arrive at a venue with purchased paper tickets in hand, and staff members scan and check the tickets using specially designed or configured devices (alternatively, staff members can check tickets manually). In a second alternative technique, customers present an e-ticket with a dynamic quick response (QR) code displayed on a terminal (such as a mobile phone) and staff members scan and check the tickets using specially designed or configured devices.

Although these two techniques are currently used by the ticketing industry for ensuring ticket uniqueness when checking tickets, these techniques have certain technical disadvantages. The first technique relies on paper-based tickets and is susceptible to ticket reuse use due to photocopying. Additionally, physical defects or marring of tickets result in difficulties authenticating such tickets. Moreover, although the second technique can use secure encryption to ensure ticket uniqueness, the QR codes of the second technique can be forged (or simulated). Thus, malicious users can undermine the security of the second technique. Finally, the second technique requires high equipment deployment and networking costs.

Additionally, both techniques described above are established based on a user's “past experience,” which places too much emphasis on personal experience. When human judgement is incorrect, it can easily result in financial losses. Therefore, the following technical problem urgently needs to be solved: how to reasonably recommend a ticket checking mode based on existing venue characteristics while ensuring the security of ticket checking.

### SUMMARY

To achieve the aforementioned objectives, the disclosed embodiments provide methods, systems, and apparatuses for ticket checking via a server-recommended ticket checking scheme. Based on existing venue characteristics, a reasonable recommendation of a ticket checking mode is achieved while the security of ticket checking is ensured. Secondary encryption is performed based on encrypted data of original tickets to improve the security and reliability of the tickets. Project information data and venue information data of a to-be-checked session are incorporated to improve ticket checking efficiency. A reasonable ticket checking mode is employed, reducing staff and equipment input and ticket checking costs.

To achieve the aforementioned objectives, a method for ticket checking via a server-recommended ticket checking scheme is disclosed which comprises: receiving a ticket checking scheme recommendation request, the ticket checking scheme recommendation request including at least ticket checking project attributes; responding to the ticket checking scheme recommendation request, retrieving a ticket checking scheme that is matching based on eligible data included in the ticket checking scheme recommendation request; matching the data included in the ticket checking scheme recommendation request with the ticket checking scheme; and setting and storing at least one form of password data for ticket checking in the ticket checking scheme after data matching.

In one embodiment, the retrieving a ticket checking scheme that is matching based on eligible data included in the ticket checking scheme recommendation request comprises: parsing the data in the ticket checking project attributes included in the received ticket checking scheme recommendation request; checking whether the data meets preset requirements of a server; if the data does not meet the requirements, sending prompt information and ending a recommendation process; and if the data meets the requirements, retrieving project session information data and venue information data stored in a storage module; and screening information data that is in the retrieved project session information data and venue information data and matches the data, and recommending a ticket checking mode according to the information data.

In one embodiment, the screening information data that is in the retrieved project session information data and venue information data and matches the data comprises: combining the retrieved project session information data and venue information data; screening to-be-checked project sessions from the combined project session information data and venue information data; and determining whether the screened to-be-checked project sessions belong to the same project; and if the screened to-be-checked project sessions belong to different projects, sending prompt information and then returning to a screening page, and if the screened to-be-checked project sessions belong to the same project, automatically recommending a ticket checking mode or self-selecting a ticket checking mode based on the to-be-checked project sessions.

In one embodiment, the ticket checking mode comprises, but is not limited to: one or more of admission by e-tickets with dynamic QR codes, admission by e-tickets with identity cards, admission by e-tickets of ordinary paper tickets, admission by radio-frequency identifier (RFID) paper tickets, and self-defined admission.

In one embodiment, the matching the data included in the ticket checking scheme recommendation request with the ticket checking scheme comprises: matching all of the data in the ticket checking project attributes included in the ticket checking scheme recommendation request with the ticket checking scheme at corresponding locations, and checking whether a format is correct; and if the format is incorrect, sending prompt data and returning to a matching page, and if the format is correct, storing matching data information.

The data in the ticket checking project attributes included in the ticket checking scheme recommendation request comprises, but is not limited to, one or more of a project name, a seat type, a ticket quantity, a venue network setup status, a venue mobile network status, and a ticket checking time.

In one embodiment, the setting and storing at least one form of password data for ticket checking in the ticket checking scheme after data matching comprises: setting one form of password data for ticket checking in the ticket checking scheme after data matching, performing a format check, and if the format check fails, sending prompt information and returning to a password setting page; and if the format check succeeds, binding the password data to the ticket checking scheme, encrypting the password data, storing the encrypted password data in a password storage module in the server, and sending a prompt box asking whether to set another form of password data for ticket checking.

In one embodiment, the form of the password data comprises, but is not limited to, one or more of a graphical password, a digital password, and a face recognition password.

Another aspect of the embodiments further provides a system for ticket checking via a server-recommended ticket checking scheme, which comprises: a receiving module, configured to receive a ticket checking scheme recommendation request, the ticket checking scheme recommendation request including at least ticket checking project attributes; a response module, configured to respond to the ticket checking scheme recommendation request to retrieve a ticket checking scheme that is matched based on eligible data included in the ticket checking scheme recommendation request, and to match the data included in the ticket checking scheme recommendation request with the ticket checking scheme; and a setting module, configured to set and store at least one form of password data for ticket checking in the ticket checking scheme after data matching.

In one embodiment, the response module comprises: a parsing unit, configured to parse the data in the ticket checking project attributes included in the received ticket checking scheme recommendation request; a check unit, configured to check whether the data meets preset requirements of a server; if the data does not meet the requirements, send prompt information and end a recommendation process; if the data meets the requirements, retrieve project session information data and venue information data stored in a storage module; and screen information data that is in the retrieved project session information data and venue information data and matches the data, and recommend a ticket checking mode according to the information data; and a matching unit, configured to match all of the data in the ticket checking project attributes included in the ticket checking scheme recommendation request with the ticket checking scheme at corresponding locations, and check whether a format is correct; and if the format is incorrect, send prompt data and return to a matching page, and if the format is correct, store matched data information, where all of the data in the ticket checking project attributes included in the ticket checking scheme recommendation request comprises, but is not limited to, one or more of a project name, a seat type, a ticket quantity, a venue network setup status, a venue mobile network status, and a ticket checking time.

In one embodiment, the check unit comprises: a combination unit, configured to combine the retrieved project session information data and venue information data; a screening unit, configured to screen to-be-checked project sessions from the combined project session information data and venue information data; and a determining unit, configured to determine whether the screened to-be-checked project sessions belong to the same project; and if the screened to-be-checked project sessions belong to different projects, send prompt information and then return to a screening page, and if the screened to-be-checked project sessions belong to the same project, automatically recommend a ticket checking mode or self-select a ticket checking mode based on the to-be-checked project sessions.

In one embodiment, the ticket checking mode comprises, but is not limited to: one or more of admission by e-tickets with dynamic QR codes, admission by e-tickets with identity cards, admission by e-tickets of ordinary paper tickets, admission by RFID paper tickets, and self-defined admission.

In one embodiment, the setting module comprises: a setting unit, configured to set one form of password data for ticket checking in the ticket checking scheme after data matching, perform a format check, and if the format check fails, send prompt information and return to a password setting page; if the format check succeeds, bind the password data to the ticket checking scheme, encrypt the password data, store the encrypted password data in a password storage module in the server, and send a prompt box asking whether to set another form of password data for ticket checking.

In one embodiment, the form of the password data comprises, but is not limited to, one or more of a graphical password, a digital password, and a face recognition password.

Another aspect of the embodiments further provides an apparatus for ticket checking via a server-recommended ticket checking scheme, which comprises the system for ticket checking via a server-recommended ticket checking scheme according to any item of the foregoing.

In the disclosed embodiments, by means of the technical solution of receiving a ticket checking scheme recommendation request, the ticket checking scheme recommendation request including at least mandatory data of ticket checking project attributes; responding to the ticket checking scheme recommendation request to retrieve a ticket checking scheme that is matched based on eligible data included in the ticket checking scheme recommendation request, and to match the data included in the ticket checking scheme recommendation request with the ticket checking scheme; and setting and storing at least one form of password data for ticket checking in the ticket checking scheme after data matching, secondary encryption can be performed on tickets of to-be-checked sessions via password data set in a server; verification for ticket authenticity can be changed from manual or local (non-Internet) data check to data check with the server end (ticket checking system background), to improve the security and reliability of the tickets. Project information data and venue information data of a to-be-checked session are combined so that ticket checking efficiency is improved, a reasonable ticket checking mode is employed, and more accurate staff and equipment input is achieved, thus reducing ticket checking costs.

### BRIEF DESCRIPTION OF THE DRAWINGS

The accompanying drawings, which are incorporated in the specification and constituting part of the specification, illustrate embodiments of the disclosure. The accompanying drawings, together with the description, serve to explain the principles of the disclosed embodiments.

FIG. 1 is a flow diagram illustrating a method for ticket checking via a server-recommended ticket checking scheme according some embodiments of the disclosure.

FIG. 2 is a block diagram of a system for ticket checking via a server-recommended ticket checking scheme according to some embodiments of the disclosure.

FIG. 3 is a block diagram of a response module according to some embodiments of the disclosure.

FIG. 4 is a block diagram of a check unit according to some embodiments of the disclosure.

FIG. 5 is a block diagram of a setting module according to some embodiments of the disclosure.

FIG. 6 is a block diagram of an apparatus for ticket checking via a server-recommended ticket checking scheme according to some embodiments of the disclosure.

### DETAILED DESCRIPTION

To enable a person skilled in the art to better understand the disclosed embodiments, the disclosed embodiments are be described clearly and completely below with reference to the drawings. The described embodiments are merely some, rather than all of the embodiments of the disclosure. Based on the disclosed embodiments, all other embodiments obtained by those of ordinary skill in the art without making creative efforts shall fall within the scope of the disclosure.

It should be noted that the terms “first,” “second,” and the like in the specification and claims of the disclosure and in the above drawings are used to distinguish similar objects and are not necessarily used to describe a specific sequence or order. It should be understood that these numbers may be interchanged where appropriate so that the embodiments described herein can be implemented in orders other than those illustrated or described herein. In addition, the terms “include” and “have” and any variations thereof are intended to cover non-exclusive inclusions. For example, processes, methods, systems, products, or devices that include a series of steps or units are not limited to steps or units that are clearly listed, but may include other steps or units not clearly listed or inherent to these processes, methods, products, or devices.

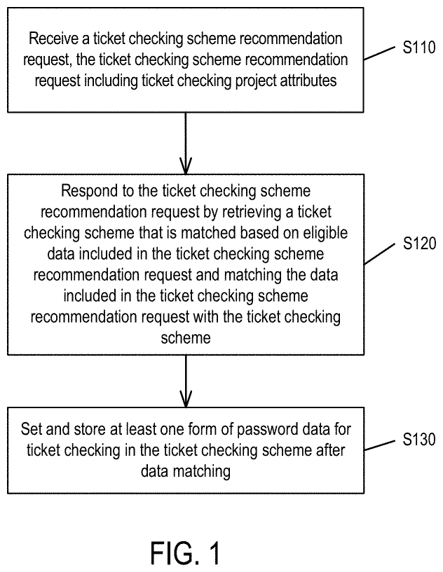

FIG. 1 is a flow diagram illustrating a method for ticket checking via a server-recommended ticket checking scheme according some embodiments of the disclosure

Step S110: receive a ticket checking scheme recommendation request, the ticket checking scheme recommendation request including ticket checking project attributes.

Step S120: respond to the ticket checking scheme recommendation request by retrieving a ticket checking scheme that is matched based on eligible data included in the ticket checking scheme recommendation request and matching the data included in the ticket checking scheme recommendation request with the ticket checking scheme.

In one embodiment of step S120, the retrieving a ticket checking scheme that is matching based on eligible data included in the ticket checking scheme recommendation request includes: parsing the eligible data in the ticket checking project attributes included in the received ticket checking scheme recommendation request; checking whether the eligible data meets preset requirements of a server. If the eligible data does not meet the requirements, the method sends prompt information and ends a recommendation process. If the eligible data meets the requirements, the method retrieves project session information data and venue information data stored in a storage module, screens information data that is in the retrieved project session information data and venue information data and matches the data, and recommends a ticket checking mode according to the information data.

In one embodiment, the screening information data that is in the retrieved project session information data and venue information data and matches the data comprises combining the retrieved project session information data and venue information data; screening to-be-checked project sessions from the combined project session information data and venue information data; and determining whether the screened to-be-checked project sessions belong to the same project. If the screened to-be-checked project sessions belong to different projects, the method sends prompt information and then returning to a screening page. If the screened to-be-checked project sessions belong to the same project, the method automatically recommends a ticket checking mode or self-selecting a ticket checking mode based on the to-be-checked project sessions. Project information data and venue information data of a to-be-checked session are combined, to solve the problem in making plans based on past experience during ticket checking.

In one embodiment, the matching the data included in the ticket checking scheme recommendation request with the ticket checking scheme includes: matching all of the data in the ticket checking project attributes included in the ticket checking scheme recommendation request with the ticket checking scheme at corresponding locations, and checking whether a format is correct. If the format is incorrect, the method sends prompt data and returning to a matching page. If the format is correct, the method stores matching data information.

The data in the ticket checking project attributes included in the ticket checking scheme recommendation request includes, but is not limited to, one or more of a project name, a seat type, a ticket quantity, a venue network setup status, a venue mobile network status, and a ticket checking time. For example, the ticket checking time includes a ticket checking start time and a ticket checking end time of a project session for explicitly specifying a ticket checking scheme.

A determination can be made according to a combination of fields of a session type, a seat type, and a ticket quantity in the project session information data and a venue map, a venue network setup status, and a venue mobile network status in the venue information data, and a ticket checking mode can be recommended.

For example, exemplary project session information data may include:

a) session type: real-name session;

b) seat type: no seat;

c) ticket quantity: 500;

d) venue network setup status: a wireless network is available; and

e) venue mobile network status: excellent.

In this scenario, “admission by e-tickets with identity cards” will be recommended as the ticket checking mode according to the example project session information data illustrated above.

Step S130: set and store at least one form of password data for ticket checking in the ticket checking scheme after data matching.

In one embodiment, step S130 includes setting one form of password data for ticket checking in the ticket checking scheme after data matching, performing a format check, and if the format check fails, sending prompt information and returning to a password setting page. If the format check succeeds, the step includes binding the password data to the ticket checking scheme, encrypting the password data, storing the encrypted password data in a password storage module in the server, and sending a prompt box asking whether to set another form of password data for ticket checking.

The server stores a check format that can be freely set depending on the situation.

A digital password check format may include the constraints that: a) there cannot be four or more consecutive digits that are the same number (e.g., 1111XX or X1111X are not allowed); and/or b) there cannot be four or more consecutive digits that are consecutive numbers (e.g., 1234XX, XX0123, or X6789X are not allowed).

A graphical password check format may include a constraint that: a) the points involved in a graphic can be connected only once.

Password encryption rules may utilize MD5 encryption based on the aforementioned password and session ID.

The project session information data may be used for storing project session information data.

The project session information data includes, but is not limited to, a project name, a project ID, a session name, a session ID, a province, a city, a performance time, a venue name, a session type (e.g., real-name session, RFID session, or e-ticket session), a seat type (e.g., seat by number, open seat, or no seat), seat information, a ticket price, a ticket quantity, and an MD5 password.

The venue information data is used for storing venue information data.

The venue information data includes, but is not limited to, a venue name, a venue ID, a province, a city, a venue map (e.g., the numbers and locations of entries and exits, working area, cast and crew area, shopping area, toilet area, audience area, audience floor, or audience seat number), an available seat quantity, a venue network setup status (e.g., generic venue network cabling diagram, availability of wireless Wi-Fi (wireless fidelity), distribution locations, signal strength, or maximum network capacity), a venue mobile network status (e.g., Mobile 4G network signals, Unicom 4G network signals, or Telecom 4G network signals), and available power outlets at the venue.

The password storage module is used for storing established ticket checking scheme information.

The ticket checking scheme information includes, but is not limited to, the name of tickets for checking, a project name, a project ID, a session name, a session ID, a province, a city, a performance time, a ticket checking start time, a ticket checking end time, the total number of tickets for checking, a venue name, a venue map, a session type (e.g., real-name session or RFID session), a seat type (e.g., seat by number, open seat, or no seat), a ticket checking mode (e.g., admission by e-tickets in ticket folders, admission by e-tickets with identity cards, admission by e-tickets of ordinary paper tickets, admission by RFID paper tickets, or self-defined admission), and an MD5 password.

Further, the form of the password data includes, but is not limited to, one or more of a graphical password, a digital password, and a face recognition password. Secondary encryption is performed on tickets of to-be-checked sessions, to solve the problem of security reduction due to that e-tickets are forged (or simulated).

The graphical password is a new identity authentication technique. The graphical password is different from conventional passwords. The graphical password uses graphics as an authentication medium. Authentication is performed through clicking, recognition, or reproduction of graphics by a customer or through interaction between the customer and a graphics system. At present, many scholars are committed to the research of the graphical password, which has been applied to personal digital assistants (PDAs), automated teller machines (ATMs), etc. Although many models are still in the theoretical research and experimental stage and are not commercially applied, the graphical password has wide development potential because of its characteristics such as high security and fun of use. Scientific research shows that humans have limited memory for text, but have much better memory for graphic images than for text. In addition, human memorize text and images in different manners. For the various reasons above, the graphical password emerged. The graphical password is a new password system that uses graphics or the like as a medium. The customer needs to perform certain operations on these graphics during identity authentication. Because of the characteristics such as large password space, flexible application, and no use of words, the graphical password is immune to brute force cracking and dictionary attacks. Besides, some graphical password systems can completely prevent shoulder surfing. In an example, the form of the password data in this embodiment may be a graphical password.

In one embodiment, the ticket checking mode includes, but is not limited to, a mode selected from the group consisting of: one or more of admission by e-tickets with dynamic QR codes, admission by e-tickets with identity cards, admission by e-tickets of ordinary paper tickets, admission by RFID paper tickets, and self-defined admission.

In the method for ticket checking via a server-recommended ticket checking scheme according to the illustrated embodiments, by means of the technical solution of receiving a ticket checking scheme recommendation request, the ticket checking scheme recommendation request including ticket checking project attributes; responding to the ticket checking scheme recommendation request, retrieving a ticket checking scheme that is matching based on eligible data included in the ticket checking scheme recommendation request, and matching the data included in the ticket checking scheme recommendation request with the ticket checking scheme; and setting and storing at least one form of password data for ticket checking in the ticket checking scheme after data matching, secondary encryption can be performed on tickets of to-be-checked sessions via password data set in a server; verification for ticket authenticity can be changed from manual or local (non-Internet) data check to data check with the server end (ticket checking system background), to improve the security and reliability of the tickets. Project information data and venue information data of a to-be-checked session are combined so that ticket checking efficiency is improved, a reasonable ticket checking mode is employed, and more accurate staff and equipment input is achieved, thus reducing ticket checking costs.

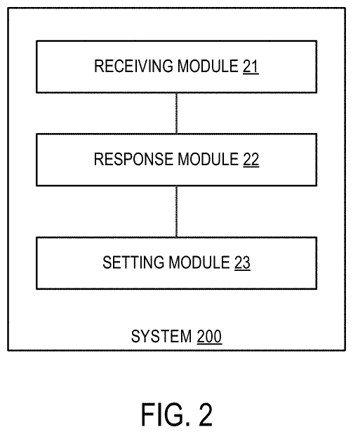

FIG. 2 is a block diagram of a system 200 for ticket checking via a server-recommended ticket checking scheme according to some embodiments of the disclosure. In the illustrated embodiment, the system 200 includes a receiving module 21, a response module 22, and a setting module 23.

The receiving module 21 is configured to receive a ticket checking scheme recommendation request, the ticket checking scheme recommendation request including ticket checking project attributes.

The response module 22 is configured to respond to the ticket checking scheme recommendation request by retrieving a ticket checking scheme that is matching based on eligible data included in the ticket checking scheme recommendation request, and matching the data included in the ticket checking scheme recommendation request with the ticket checking scheme.

The setting module 23 is configured to set and store at least one form of password data for ticket checking in the ticket checking scheme after data matching.

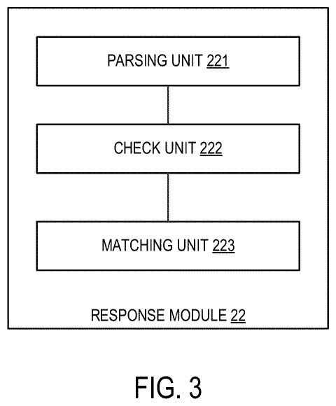

FIG. 3 is a block diagram of a response module according to some embodiments of the disclosure. The response module 22 may include a parsing unit 221, a check unit 222, and a matching unit 223.

The parsing unit 221 is configured to parse the data in the ticket checking project attributes included in the received ticket checking scheme recommendation request.

The check unit 222 is configured to check whether the data meets preset requirements of a server. If the data does not meet the requirements, the check unit 222 sends prompt information and end a recommendation process. If the data meets the requirements, check unit 222 retrieves project session information data and venue information data stored in a storage module, screens information data that is in the retrieved project session information data and venue information data and matches the data, and recommends a ticket checking mode according to the information data.

The matching unit 223 is configured to match the data in the ticket checking project attributes included in the ticket checking scheme recommendation request with the ticket checking scheme at corresponding locations, and check whether a format is correct. If the format is incorrect, the matching unit 223 sends prompt data and return to a matching page. If the format is correct, the matching unit 223 stores matched data information.

Data in the ticket checking project attributes included in the ticket checking scheme recommendation request includes, but is not limited to, one or more of a project name, a seat type, a ticket quantity, a venue network setup status, a venue mobile network status, and a ticket checking time.

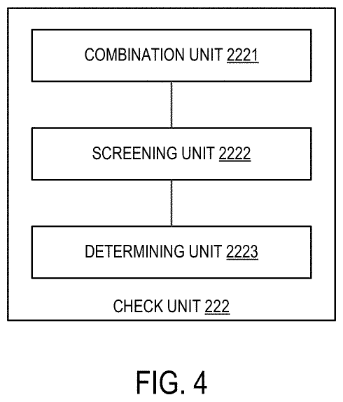

FIG. 4 is a block diagram of a check unit according to some embodiments of the disclosure. As illustrated, the check unit 222 may include a combination unit 2221, a screening unit 2222, and a determining unit 2223.

The combination unit 2221 is configured to combine the retrieved project session information data and venue information data.

The screening unit 2222 is configured to screen to-be-checked project sessions from the combined project session information data and venue information data.

The determining unit 2223 is configured to determine whether the screened to-be-checked project sessions belong to the same project. If the screened to-be-checked project sessions belong to different projects, the determining unit 2223 sends prompt information and then returns to a screening page. If the screened to-be-checked project sessions belong to the same project, the determining unit 2223 automatically recommends a ticket checking mode or self-select a ticket checking mode based on the to-be-checked project sessions.

In one embodiment, the ticket checking mode includes, but is not limited to, a mode selected from the group consisting of: one or more of admission by e-tickets with dynamic QR codes, admission by e-tickets with identity cards, admission by e-tickets of ordinary paper tickets, admission by RFID paper tickets, and self-defined admission.

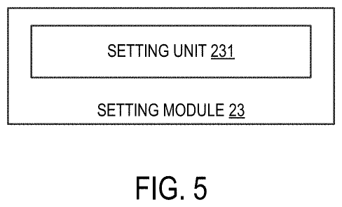

FIG. 5 is a block diagram of a setting module according to some embodiments of the disclosure. As illustrated, the setting module 23 includes a setting unit 231.

The setting unit 231 is configured to set one form of password data for ticket checking in the ticket checking scheme after data matching, perform a format check, and if the format check fails, send prompt information and return to a password setting page. If the format check succeeds, the setting unit 231 binds the password data to the ticket checking scheme, encrypts the password data, stores the encrypted password data in a password storage module in the server, and sends a prompt box asking whether to set another form of password data for ticket checking.

In one embodiment, the form of the password data includes, but is not limited to, one or more of a graphical password, a digital password, and a face recognition password.

The system 200 for ticket checking via a server-recommended ticket checking scheme according to this embodiment may include a memory and a processor.

The processor may be a central processing unit (CPU), a microprocessor (MCU), or similar device.

The memory includes, for example, a ROM (read-only memory), a RAM (random access memory), or a non-volatile memory such as a hard disk.

The memory is configured to store instructions for controlling the processor to operate to perform the method for ticket checking at a customer end according to one embodiment.

The apparatus 300 (discussed further herein) for ticket checking via a server-recommended ticket checking scheme according to some embodiments may further include an interface device, a communications device, an input device, a speaker, a microphone, and the like.

The interface device includes, for example, a USB interface or an earphone interface. The communications device can perform, for example, wired or wireless communications, which may specifically include Wi-Fi communications, Bluetooth communications, 2G/3G/4G/5G communications, and so on. The input device may include, for example, a touch screen, a keyboard, or a somatosensory input. A customer can input/output voice information via the speaker and the microphone.

Since the processing and function implemented by the system according to the embodiments described in the description of FIGS. 2 through 5 correspond to the embodiments, principles, and examples of the foregoing methods discussed in the description of FIG. 1, reference may be made to the relevant description in the foregoing embodiment for a part that is not detailed in the description of these embodiments, which will not be described herein again. In the system for ticket checking based on a server-recommended ticket checking scheme according to the embodiments described in the description of FIGS. 2 through 5, by means of the technical solution that the receiving module receives a ticket checking scheme recommendation request, the ticket checking scheme recommendation request including at least mandatory data in ticket checking project attributes; the response module responds to the ticket checking scheme recommendation request, retrieves a ticket checking scheme that is matching based on eligible data included in the ticket checking scheme recommendation request, and matches the data included in the ticket checking scheme recommendation request with the ticket checking scheme; and the setting module sets and stores at least one form of password data for ticket checking in the ticket checking scheme after data matching, secondary encryption can be performed on tickets of to-be-checked sessions via password data set in a server; verification for ticket authenticity can be changed from manual or local (non-Internet) data check to data check with the server end (ticket checking system background), so as to improve the security and reliability of the tickets. Project information data and venue information data of a to-be-checked session are combined so that ticket checking efficiency is improved, a reasonable ticket checking mode is employed, and more accurate staff and equipment input is achieved, thus reducing ticket checking costs.

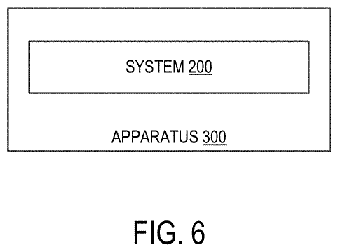

FIG. 6 is a block diagram of an apparatus 300 for ticket checking via a server-recommended ticket checking scheme according to some embodiments of the disclosure, which includes the system 200 for ticket checking via a server-recommended ticket checking scheme according to the embodiments described in the description of FIGS. 2 through 5.

The apparatus 300 for ticket checking via a server-recommended ticket checking scheme according to this embodiment may include a memory and a processor.

The processor may be a central processing unit (CPU), a microprocessor (MCU), or similar devices.

The memory includes, for example, a ROM (read-only memory), a RAM (random access memory), or a non-volatile memory such as a hard disk.

The memory is configured to store instructions for controlling the processor to operate to perform the method for ticket checking at a customer end according to one embodiment.

The apparatus 300 for ticket checking via a server-recommended ticket checking scheme according to this embodiment may further include an interface device, a communications device, an input device, a speaker, a microphone, etc.

The interface device includes, for example, a USB interface or an earphone interface. The communications device can perform, for example, wired or wireless communications, which may specifically include Wi-Fi communications, Bluetooth communications, 2G/3G/4G/5G communications, and so on. The input device may include, for example, a touch screen, a keyboard, or a somatosensory input. A customer can input/output voice information via the speaker and the microphone.

In the apparatus for ticket checking based on a server-recommended ticket checking scheme according to the embodiments described in the description of FIG. 6, by means of the technical solution of receiving a ticket checking scheme recommendation request, the ticket checking scheme recommendation request including at least mandatory data in ticket checking project attributes; responding to the ticket checking scheme recommendation request, retrieving a ticket checking scheme that is matching based on eligible data included in the ticket checking scheme recommendation request, and matching the data included in the ticket checking scheme recommendation request with the ticket checking scheme; and setting and storing at least one form of password data for ticket checking in the ticket checking scheme after data matching, secondary encryption can be performed on tickets of to-be-checked sessions via password data set in a server; verification for ticket authenticity can be changed from manual or local (non-Internet) data check to data check with the server end (ticket checking system background), so as to improve the security and reliability of the tickets. Project information data and venue information data of a to-be-checked session are combined so that ticket checking efficiency is improved, a reasonable ticket checking mode is employed, and more accurate staff and equipment input is achieved, thus reducing ticket checking costs.

The sequence numbers of the foregoing embodiments are merely for description and do not indicate advantages or disadvantages of the embodiments.

It should be noted that to briefly describe each foregoing method embodiment, all the method embodiments are expressed as a combination of a series of actions; but those skilled in the art should know that the embodiments are not limited by the sequence of the described actions. Certain steps can be applied with different sequences or can be included out at the same time according to the disclosed embodiments. Secondly, those skilled in the art should also know that all the embodiments described in the specification are exemplary embodiments; the related actions and modules are not necessarily needed for each embodiment.

In the embodiments above, the description of each embodiment has its own focus; and references for those that are not described in detail in a certain embodiment can be made by referring to the related descriptions of other embodiments.

In the several embodiments, the disclosed apparatus can be implemented in other manners. For example, the apparatus embodiment described above is merely exemplary. For example, the division of the units is merely a logical function division; other divisions in practical implementation may exist, like a plurality of units or components can be combined or can be integrated into another system; or some features can be ignored or not executed. Additionally, the mutual coupling, direct coupling, or communication connection displayed or discussed may be implemented by some interfaces, and the indirect coupling or communication connection between apparatuses or units may be in electrical or other forms.

The units described as separate parts may or may not be physically separated; and the parts shown as units may or may not be physical units, which may be located in one place or may be distributed onto a plurality of network units. The objective of the solution of this embodiment may be achieved by selecting part or all of the units according to actual requirements.

In addition, each functional unit in each embodiment may be integrated in one processing unit, or each unit may exist physically independently, or two or more units may be integrated in one unit. The integrated unit may be implemented in the form of hardware, and may also be implemented in the form of a software functional unit.

It should be noted that various steps/components described in the disclosure may be split into more steps/components, depending on the need for implementation, or two or more steps/components or some operations of the steps/components may be combined into new steps/components to achieve the objective of the disclosure.

The disclosed embodiments may be apparatuses, methods, and/or computer program products. The computer program product may include a computer-readable storage medium, having computer-readable program instructions thereon for causing a processor to implement various aspects of the disclosure.

The above method according to the disclosed embodiments may be implemented in hardware or firmware, or may be implemented as software or computer code that can be stored in a recording medium (such as a CD ROM, a RAM, a floppy disk, a hard disk, or a magneto-optical disk), or may be implemented as computer code downloaded through a network, originally stored in a remote recording medium or a non-transitory machine-readable medium and will be stored in a local recording medium, so that the method described herein can be processed by software stored in a recording medium using a general-purpose computer, a dedicated processor, or programmable or dedicated hardware (such as an ASIC or FPGA). It can be understood that the computer, processor, microprocessor controller, or programmable hardware includes a storage component (e.g., a RAM, a ROM, or a flash memory) capable of storing or receiving software or computer code that, when accessed and executed by the computer, processor, or hardware, implements the processing method described herein. In addition, when the general-purpose computer accesses the code for implementing the processing shown herein, the execution of the code converts the general-purpose computer into a special-purpose computer for performing the processing shown herein.

The computer-readable storage medium may be a tangible device that can retain and store instructions for use by an instruction execution device. The computer-readable storage medium may be, for example, but is not limited to, an electrical storage device, a magnetic storage device, an optical storage device, an electromagnetic storage device, a semiconductor storage device, or any suitable combination of the foregoing. (A non-exhaustive list of) more specific examples of the computer-readable storage medium includes: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions stored thereon, and any suitable combination of the foregoing. The computer-readable storage medium used herein is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable program instructions described herein can be downloaded to respective computing/processing devices from the computer-readable storage medium or to an external computer or external storage device through a network, for example, the Internet, a local area network, a wide area network and/or a wireless network. The network may include copper transmission cables, optical fiber transmission, wireless transmission, routers, firewalls, switches, gateway computers and/or edge servers. A network adapter card or network interface in each computing/processing device receives the computer-readable program instructions from the network and forwards the computer-readable program instructions for storage in the computer-readable storage medium within the respective computing/processing devices.

The computer program instructions for including operations may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk and C++, and conventional procedural programming languages, such as the “C” language or similar programming languages. The computer-readable program instructions may be executed entirely on the customer's computer, partly on the customer's computer, as a stand-alone software package, partly on the customer's computer and partly on a remote computer or entirely on the remote computer or server. In the scenario involving the remote computer, the remote computer may be connected to the customer's computer through any type of network, including a local area network (LAN) or a wide area network (WAN), or the connection may be made to an external computer (e.g., through the Internet using an Internet service provider). In some embodiments, an electronic circuit, for example, a programmable logic circuit, a field-programmable gate array (FPGA), or a programmable logic array (PLA), may execute the computer-readable program instructions by utilizing state information of the computer-readable program instructions to personalize the electronic circuit, to implement various aspects of the disclosure.

Various aspects of the disclosure are described herein with reference to flowcharts and/or block diagrams of the method, apparatus (system), and computer program product according to the disclosed embodiments. It should be understood that each block of the flowcharts and/or block diagrams, and combinations of blocks in the flowcharts and/or block diagrams, can be implemented by computer-readable program instructions.

These computer-readable program instructions may be provided to a processor of a general-purpose computer, special-purpose computer, or other programmable data processing apparatus to produce a machine, such that the instructions, when executed through the processor of the computer or other programmable data processing apparatus, create means for implementing the functions/acts specified in one or more blocks in the flowcharts and/or block diagrams. These computer-readable program instructions may also be stored in a computer-readable storage medium that can direct a computer, a programmable data processing apparatus and/or other device to function in a particular manner, such that the computer-readable storage medium having instructions stored therein includes an article of manufacture including instructions which implement various aspects of the functions/acts specified in one or more blocks in the flowcharts and/or block diagrams.

The computer-readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement functions/acts specified in one or more blocks in the flowcharts and/or block diagrams.

The flowcharts and block diagrams in the figures illustrate the architecture, functionality, and operation of possible implementations of the system, method, and computer program product according to the multiple embodiments. In this regard, each block in the flowcharts or block diagrams may represent a module, program segment, or portion of instructions, which includes one or more executable instructions for implementing the specified logical functions. In some alternative implementations, the functions noted in the block may occur out of the order noted in the figures. For example, two blocks in succession may, in fact, be executed substantially concurrently, or the blocks may sometimes be executed in the reverse order, depending upon the functionality involved. It will also be noted that each block in the block diagrams and/or flowcharts, and combinations of blocks in the block diagrams and/or flowcharts, can be implemented by special-purpose hardware-based systems that execute the specified functions or acts or by a combination of special-purpose hardware and computer instructions. It is well-known to those skilled in the art that the implementation by hardware, implementation by software, and implementation by a combination of software and hardware are equivalent.

The above descriptions are merely specific implementations of the disclosed embodiments, but the scope of the disclosure is not limited thereto. Variations or replacements readily apparent to those skilled in the art within the technical scope of the disclosed embodiments fall within the scope of the disclosure. Therefore, the scope of the disclosed embodiments is subject to the appended claims.

1-14. (canceled)

15. A method comprising:
receiving a ticket checking scheme recommendation request at a ticket-checking device, the ticket checking scheme recommendation request including ticket checking project attributes;
retrieving a ticket checking scheme matching eligible data extracted from the project attributes;
mapping data in the ticket checking scheme recommendation with the ticket checking scheme; and
setting and storing at least one form of password data for ticket checking in the ticket checking scheme after matching the data.

16. The method of claim 15, the retrieving a ticket checking scheme matching eligible data extracted from the project attributes comprising:
parsing the eligible data from the project attributes;
checking whether the eligible data meets preset requirements of a server;
sending prompt information if the data does not meet the requirements; and
if the data meets the requirements:
retrieving project session information data and venue information data,
screening data in the project session information data and venue information data, the screened data matching the eligible data, and
recommending a ticket checking mode according to the screened data.

17. The method of claim 16, the screening data in the project session information data and venue information data comprising:
combining the project session information data and venue information data;
screening to-be-checked project sessions from the combined project session information data and venue information data;
determining whether the screened to-be-checked project sessions belong to the same project;
sending prompt information and then returning to a screening page, if the screened to-be-checked project sessions belong to different projects; and
automatically recommending a ticket checking mode or self-selecting a ticket checking mode based on the to-be-checked project sessions if the screened to-be-checked project sessions belong to the same project.

18. The method of claim 16, the ticket checking mode comprising a mode selected from the group consisting of admission using e-tickets with dynamic quick response (QR) codes, admission using e-tickets with identity cards, admission using e-tickets of ordinary paper tickets, admission using radio-frequency identifier (RFID) paper tickets, and self-defined admission.

19. The method of claim 15, the mapping data in the ticket checking scheme recommendation with the ticket checking scheme comprising:
mapping the data in the ticket checking scheme recommendation request with the ticket checking scheme to corresponding locations, and checking whether a format is correct;
if the format is incorrect, sending prompt data and returning to a matching page; and
if the format is correct, storing matching data information, the data in the ticket checking project attributes included in the ticket checking scheme recommendation request comprising one or more of a project name, a seat type, a ticket quantity, a venue network setup status, a venue mobile network status, and a ticket checking time.

20. The method of claim 15, the setting and storing at least one form of password data for ticket checking in the ticket checking scheme after matching the data comprising:
setting one form of password data for ticket checking in the ticket checking scheme after the mapping and performing a format check;
if the format check fails, sending prompt information and returning to a password setting page; and
if the format check succeeds:
binding the password data to the ticket checking scheme,
encrypting the password data,
storing the encrypted password data in a password storage module in the server, and
sending a prompt box asking whether to set another form of password data for ticket checking.

21. The method of claim 15, the form of the password data comprising a form selected from the group consisting of a graphical password, a digital password, and a face recognition password.

22. A non-transitory computer readable storage medium for tangibly storing computer program instructions capable of being executed by a computer processor, the computer program instructions defining the steps of:
receiving a ticket checking scheme recommendation request at a ticket-checking device, the ticket checking scheme recommendation request including ticket checking project attributes;
retrieving a ticket checking scheme matching eligible data extracted from the project attributes;
mapping data in the ticket checking scheme recommendation with the ticket checking scheme; and
setting and storing at least one form of password data for ticket checking in the ticket checking scheme after matching the data.

23. The non-transitory computer readable storage medium of claim 22, the retrieving a ticket checking scheme matching eligible data extracted from the project attributes comprising:
parsing the eligible data from the project attributes;
checking whether the eligible data meets preset requirements of a server;
sending prompt information if the data does not meet the requirements; and
if the data meets the requirements:
retrieving project session information data and venue information data,
screening data in the project session information data and venue information data, the screened data matching the eligible data, and
recommending a ticket checking mode according to the screened data.

24. The non-transitory computer readable storage medium of claim 23, the screening data in the project session information data and venue information data comprising:
combining the project session information data and venue information data;
screening to-be-checked project sessions from the combined project session information data and venue information data;
determining whether the screened to-be-checked project sessions belong to the same project;
sending prompt information and then returning to a screening page, if the screened to-be-checked project sessions belong to different projects; and
automatically recommending a ticket checking mode or self-selecting a ticket checking mode based on the to-be-checked project sessions if the screened to-be-checked project sessions belong to the same project.

25. The non-transitory computer readable storage medium of claim 23, the ticket checking mode comprising a mode selected from the group consisting of admission using e-tickets with dynamic quick response (QR) codes, admission using e-tickets with identity cards, admission using e-tickets of ordinary paper tickets, admission using radio-frequency identifier (RFID) paper tickets, and self-defined admission.

26. The non-transitory computer readable storage medium of claim 22, the mapping data in the ticket checking scheme recommendation with the ticket checking scheme comprising:
mapping the data in the ticket checking scheme recommendation request with the ticket checking scheme to corresponding locations, and checking whether a format is correct;
if the format is incorrect, sending prompt data and returning to a matching page; and
if the format is correct, storing matching data information, the data in the ticket checking project attributes included in the ticket checking scheme recommendation request comprising one or more of a project name, a seat type, a ticket quantity, a venue network setup status, a venue mobile network status, and a ticket checking time.

27. The non-transitory computer readable storage medium of claim 22, the setting and storing at least one form of password data for ticket checking in the ticket checking scheme after matching the data comprising:
setting one form of password data for ticket checking in the ticket checking scheme after the mapping and performing a format check;
if the format check fails, sending prompt information and returning to a password setting page; and
if the format check succeeds:
binding the password data to the ticket checking scheme,
encrypting the password data,
storing the encrypted password data in a password storage module in the server, and
sending a prompt box asking whether to set another form of password data for ticket checking.

28. The non-transitory computer readable storage medium of claim 22, the form of the password data comprising a form selected from the group consisting of a graphical password, a digital password, and a face recognition password.

29. A device comprising:
a processor; and
a storage medium for tangibly storing thereon program logic for execution by the processor, the stored program logic comprising:
logic, executed by the processor, for receiving a ticket checking scheme recommendation request at a ticket-checking device, the ticket checking scheme recommendation request including ticket checking project attributes;
logic, executed by the processor, for retrieving a ticket checking scheme matching eligible data extracted from the project attributes;
logic, executed by the processor, for mapping data in the ticket checking scheme recommendation with the ticket checking scheme; and
logic, executed by the processor, for setting and storing at least one form of password data for ticket checking in the ticket checking scheme after matching the data.

30. The device of claim 29, the logic for retrieving a ticket checking scheme matching eligible data extracted from the project attributes comprising:
logic, executed by the processor, for parsing the eligible data from the project attributes;
logic, executed by the processor, for checking whether the eligible data meets preset requirements of a server;
logic, executed by the processor, for sending prompt information if the data does not meet the requirements; and
logic, executed by the processor, for, if the data meets the requirements, retrieving project session information data and venue information data, screening data in the project session information data and venue information data, the screened data matching the eligible data, and recommending a ticket checking mode according to the screened data.

31. The device of claim 30, the logic for screening data in the project session information data and venue information data comprising:
logic, executed by the processor, for combining the project session information data and venue information data;
logic, executed by the processor, for screening to-be-checked project sessions from the combined project session information data and venue information data;
logic, executed by the processor, for determining whether the screened to-be-checked project sessions belong to the same project;
logic, executed by the processor, for sending prompt information and then returning to a screening page, if the screened to-be-checked project sessions belong to different projects; and
logic, executed by the processor, for automatically recommending a ticket checking mode or self-selecting a ticket checking mode based on the to-be-checked project sessions if the screened to-be-checked project sessions belong to the same project.

32. The device of claim 30, the ticket checking mode comprising a mode selected from the group consisting of admission using e-tickets with dynamic quick response (QR) codes, admission using e-tickets with identity cards, admission using e-tickets of ordinary paper tickets, admission using radio-frequency identifier (RFID) paper tickets, and self-defined admission.

33. The device of claim 29, the logic for mapping data in the ticket checking scheme recommendation with the ticket checking scheme comprising:
logic, executed by the processor, for mapping the data in the ticket checking scheme recommendation request with the ticket checking scheme to corresponding locations, and checking whether a format is correct;
logic, executed by the processor, for, if the format is incorrect, sending prompt data and returning to a matching page; and
logic, executed by the processor, for, if the format is correct, storing matching data information, the data in the ticket checking project attributes included in the ticket checking scheme recommendation request comprising one or more of a project name, a seat type, a ticket quantity, a venue network setup status, a venue mobile network status, and a ticket checking time.

34. The device of claim 29, the logic for setting and storing at least one form of password data for ticket checking in the ticket checking scheme after matching the data comprising:
logic, executed by the processor, for, setting one form of password data for ticket checking in the ticket checking scheme after the mapping and performing a format check;
logic, executed by the processor, for, if the format check fails, sending prompt information and returning to a password setting page; and
logic, executed by the processor, for, if the format check succeeds: binding the password data to the ticket checking scheme, encrypting the password data, storing the encrypted password data in a password storage module in the server, and sending a prompt box asking whether to set another form of password data for ticket checking.
